(19) United States
(12) Patent Application Publication
(10) Pub. No.: US 2014/0258466 A1
(43) Pub. Date: Sep. 11, 2014

(54) SYSTEM AND METHOD FOR GENERATING REVENUE FROM DISPLAYING CONTENT ITEMS

(71) Applicant: Google Inc., (US)

(72) Inventors: Andrei Zary Broder, Palo Alto, CA (US); Randolph Preston McAfee, San Marino, CA (US); Prabhakar Raghavan, Saratoga, CA (US)

(73) Assignee: Google Inc., Mountain View, CA (US)

(21) Appl. No.: 13/794,130

(22) Filed: Mar. 11, 2013

(51) Int. Cl. H04L 29/08

(52) U.S. Cl. CPC H04L 67/02
USPC 709/219

(57) ABSTRACT

System and method for determining a first location of a network accessible device from a location associated with a content item provider when a content item is displayed thereon. A second location of the network accessible device from the location associated with the content item provider is also determined during a predetermined amount of time after the content item is displayed on the network accessible device. The method and system can also operate to determine data responsive to a change in distance between the first location and the second location. The data can then be provided a status value to be used by the content item selector.

### BACKGROUND

Today, many content providers or publishers provide content through Internet websites or mobile applications running on mobile devices. The content provided by such content providers or publishers may include, or may be accompanied by certain content items (such as advertisements) from content item providers (advertisers). Typically, content item providers transfer a specified amount of money to the publishers via a content item facilitator.

### SUMMARY

Various embodiments disclosed herein are generally directed to an apparatus and method for determining a change in distance of a user of a network accessible device (NAD) with respect to an advertiser's location once a content item is displayed on the NAD.

In accordance with some embodiments, a computer-implemented method comprises displaying a content item associated with a content provider on an NAD, the content item provided to the NAD by a content item selector. A first distance between the NAD and a location associated with the content provider is detected. A second distance is detected between the NAD and the location associated with the content provider. The change in distance between the first and second distances is determined. Finally, data is stored in a memory of the content item selector that associates the change in distance with the displayed content item.

In accordance with another embodiment, an apparatus includes a memory which stores a population of content items from content providers available to be provided to an NAD, the content item provided to the NAD by a content item selector. The apparatus further includes a location analysis engine adapted to determine a first distance of the NAD from a location associated with the content provider, determine a second distance of the NAD from the location associated with the content provider, determine a change in distance between the first distance and the second distance, and store data in a memory of the content item selector that associates the change in distance with the displayed content item, the second distance being the closest distance the NAD is to the location associated with the content provider during a predetermined amount of time after the content item is displayed on the NAD. Also included in the apparatus is a second memory for storing the first distance, the second distance, the change in distance, and the stored data associated with the change in distance with the displayed content item.

Another embodiment of the disclosure includes a computer-readable data storage medium on which is stored programming instructions adapted for execution by one or more processors to: display a content item associated with a content provider on an NAD, the content item provided to the NAD by a content item selector. The instructions on the medium also detect a first distance between the NAD and a location associated with the content provider. The medium further determines a second distance between the NAD and the location associated with the content provider and determines a change in distance between the first and second distances. Finally, the medium is adapted to store data in a memory of the content item selector that associates the change in distance with the displayed content item.

These and other features and advantages which may characterize various embodiments can be understood in view of the following detailed discussion and the accompanying drawings.

### BRIEF DESCRIPTION OF THE DRAWINGS

FIG. 1 provides a functional block representation of a network-based system in accordance with various embodiments.

FIG. 2 provides another functional block representation of the network-based system in accordance with various embodiments.

FIGS. 3A and 3B illustrate various exemplary embodiments of content items and publisher content layouts on web pages.

FIG. 4 is a graphical representation of an NAD's distance from a location associated with a content item provider over a given amount of time.

FIG. 5 is a graphical representation of NADs and WiFi zones in accordance with various embodiments.

FIG. 6 is a flow chart that summarizes broad steps that may be carried out in accordance with various embodiments.

FIG. 7 is another flow chart that summarizes broad steps that may be carried out in accordance with various embodiments.

FIG. 8 is yet another flow chart that summarizes broad steps that may be carried out in accordance with various embodiments.

### DETAILED DESCRIPTION

The present disclosure generally relates to a method and system for using the data associated with the display of a content item based upon a change in distance of a user of an NAD (NAD) with respect to an advertiser's location once the content item is displayed on the NAD.

When a user of an NAD requests information from a publisher on the user's NAD, a publisher display (e.g., Internet web display) is often uploaded to the user's NAD. The publisher display may include, but is not limited to a web page, a mobile application, an e-reader book, an email service, a search engine, a game, etc. In one embodiment, the user can install a content-providing application or game that can request permission to read GPS or WiFi data associate with the user's NAD.

A publisher display may include publisher provided content and other content items. The other content items may be selected from a population of available content items from various third party content providers. The content items may take a variety of forms, and be supplied from a variety of different content item providers (or content providers). Content items can be adapted to be advertisements (ads) and placed in an ad slot of the publisher display. In some situations, content items include an interactive portion that user selection (a “click”) of the content item will connect the user to a linked web page with additional information, often referred to as a “landing page.”

Typically, when content items are selected by a content item selector to be displayed on the NAD, money is transferred from the content item provider to the publisher, via the content item selector, whereby the content item selector retains a portion of the money for their services. It should be understood and appreciated that the content item selector can function in any manner known in the art to select content items to be displayed on a user's NAD.

In one embodiment of the disclosure, once the content item is selected to be displayed on the user's NAD, data is generated that is responsive to a change in distance of the user of the NAD after the content item is displayed on the user's NAD. When a content item is uploaded on a user's NAD, the system can determine the original distance the user's NAD (and thus the user) is from a location (e.g., a storefront or business location) associated with the content item provider when the content item is loaded on the user's NAD. For a predetermined amount of time after the content item is uploaded to the user's NAD, the distance and change in distance of the user's NAD from the location associated with the content item provider can be determined. Similarly, the user's NAD location relative to the original distance the user's NAD was from the location associated with the content item provider can be determined. The predetermined amount of time can be any time frame decided upon by the content item selector. In one embodiment, the predetermined amount of time is less than about one day. In another embodiment, the predetermined amount of time is the amount of time left in the day prior to midnight of the day the content item is uploaded to the user's NAD.

The stored data associated with the change in distance of the user of the NAD after the content item is displayed on the user's NAD can be used in various manners. The change in distance and/or the location associated with the second distance can be given a status value. The status value can be any information usable by the content item selector. In one embodiment, the status value can correspond to varying amounts of revenue that can be transferred from the content provider to the content item selector.

In another embodiment, the closest distance the user's NAD is to the location associated with the content item provider is determined during the predetermined amount of time after the content item is displayed on the user's NAD. The status value is responsive to the difference in distance between the closest distance the user's NAD is to the location associated with the content item provider and the original distance the user's NAD was to the location associated with the content item provider. For example, the status value increases as the difference in distance between the original location of the user's NAD and the closest location to the location associated with the content item provider increases within the predetermined amount of time.

In yet another embodiment, a status value is only given if the distance between the user's NAD and the location associated with the content item provider decreases during the predetermined amount of time after the content item is uploaded to the user's NAD. In a further embodiment, a status value is only given if the distance between the user's NAD and the location associated with the content item provider decreases by a predetermined distance (i.e., the user comes within a predetermined distance of the location associated with the content item provider). In another embodiment, a status value is only given if the closest distance of the user's NAD to the location associated with the content item provider is a predetermined percentage of the original distance the user's NAD was from the location associated with the content item provider. For example, the predetermined percentage could be at least 90%, at least 75%, at least 50%, at least 25%, etc.

In yet another embodiment, the status value could be a function of the change in distance of the user's NAD from the original distance to the closest distance. In an exemplary embodiment, the status value is directly proportional to the predetermined percentage (or ratios) of the closest distance (D_{C}) to the original distance (D_{O}). For example, if D_{C}/D_{O} is 90%, then the status value would be X. If D_{C}/D_{O} is 75%, then the status value would be X plus Y. If D_{C}/D_{O} is 50%, then the status value would be X plus Y plus Z. It should be understood and appreciated that the status value given in accordance with this disclosure can be any function of the original distance, the closest distance and/or the change in distance between the two.

The location of the user's NAD can be determined in any manner known in the art for determining the location of a mobile NAD. In one embodiment, the location of the user's NAD can be determined via a global positioning system (GPS) associated with the user's NAD. In another embodiment, the location of the user's NAD can be determined by the user's NAD being present in various WiFi zones. WiFi zones are present in numerous locations and when an NAD enters a WiFi zone, the NAD has a “handshake” with the WiFi. The handshake is essentially an acknowledgement between the NAD and the WiFi that the NAD is in the WiFi zone and can use that zone's WiFi if the user of the NAD so chooses and has the appropriate password, if required. As the user of an NAD moves about and passes through various WiFi zones, the handshakes can provide various locations of the user's NAD. These various locations associated with the handshakes between the user's NAD and the WiFi zones can be used to determine the original distance of the user's NAD and the closest distance from the location associated with the content item provider.

In a further embodiment, after the content item is uploaded to the user's NAD, the user's NAD may be determined to be within the range of a WiFi zone associated with the content item provider within the predetermined amount of time. In this scenario, another status value can be given due to the change in distance between the original distance and the closest distance essentially being zero. It should be understood and appreciated that a user's NAD handshaking with the WiFi associated with the content item provider does not ensure that the user is actually in the content item provider's business location, only within the WiFi zone.

In one embodiment, a unique identifier of the user's NAD is determined by the content item selector when the content item is displayed thereon. Similarly, the content item provider can determine the unique identifier's of NADs that enter the WiFi zone associated with the content item provider. The unique identifier's of the NADs determined by the content item selectors can be verified against the unique identifier's of the NADs determined to be within the WiFi zone associated with the content item provider during the predetermined amount of time discussed herein. It should be understood and appreciated that no personal user information would be determined by the content item selector or the content item provider.

The system and method can also be adapted to apply to applications of search ads. For example, a search for an address can be executed with a search engine on a mobile NAD. Once the address is displayed after the search, the cost associated with that display to the advertiser increases as the user of the NAD is determined to have moved in the direction of the address from the search request, or the NAD is determined to be located within a predetermined distance of the address from the search request. In another embodiment of the present disclosure, the system and method can be adapted to compete with click ads in a marketplace in a given geographical region.

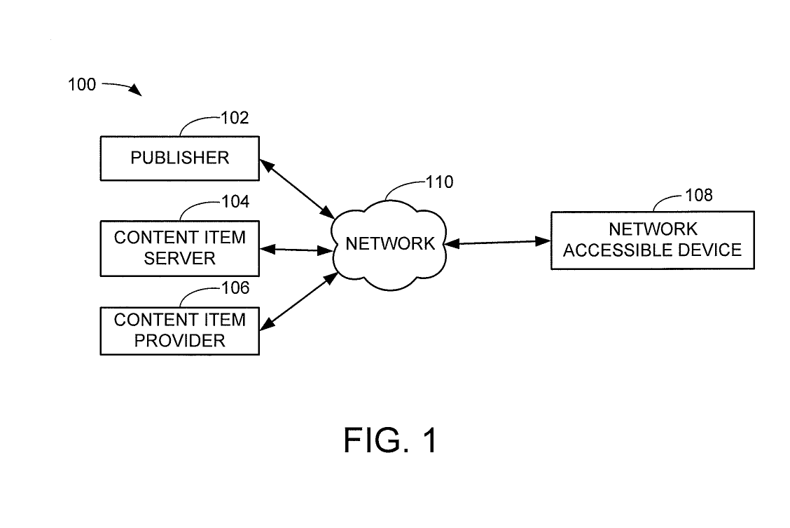

These and other features and benefits can be understood beginning with a review of FIG. 1 which depicts a network-based, user-selected content transfer system 100, constructed and operated in accordance with various embodiments. For purposes of providing a concrete example, the present discussion will contemplate the provision of content items in the form of advertisements (ads) to various publisher web pages. It will be appreciated, however, that this is merely illustrative and not limiting to the scope of the present disclosure.

The system 100 incorporates a number of active elements including a publisher 102, a content item server 104, a content item provider server 106, and at least one user network accessible device (NAD) 108, all of which communicate over one or more network 110.

The publisher 102 may represent a web page hosting server or similar system adapted to display one or more web pages from a website of a publisher (e.g., source of the website). The content item server 104 services content item requests to display content items in conjunction with the web pages. The content item provider 106 can be any content provider that is the source or owner of content items placed on a publisher display along with publisher content.

The user devices 108 represent individual NADs, such as desktop computers, laptop computers, smart phones, tablets, gaming consoles, televisions, and similar devices adapted to interact with the publisher 102, content item server 104, and content item provider 106.

The network 110 can take any suitable form(s) such as a wide area network (WAN), a local area network (LAN), a broadband wireless network, etc. It will be appreciated that other elements may be incorporated into the system 100, as desired.

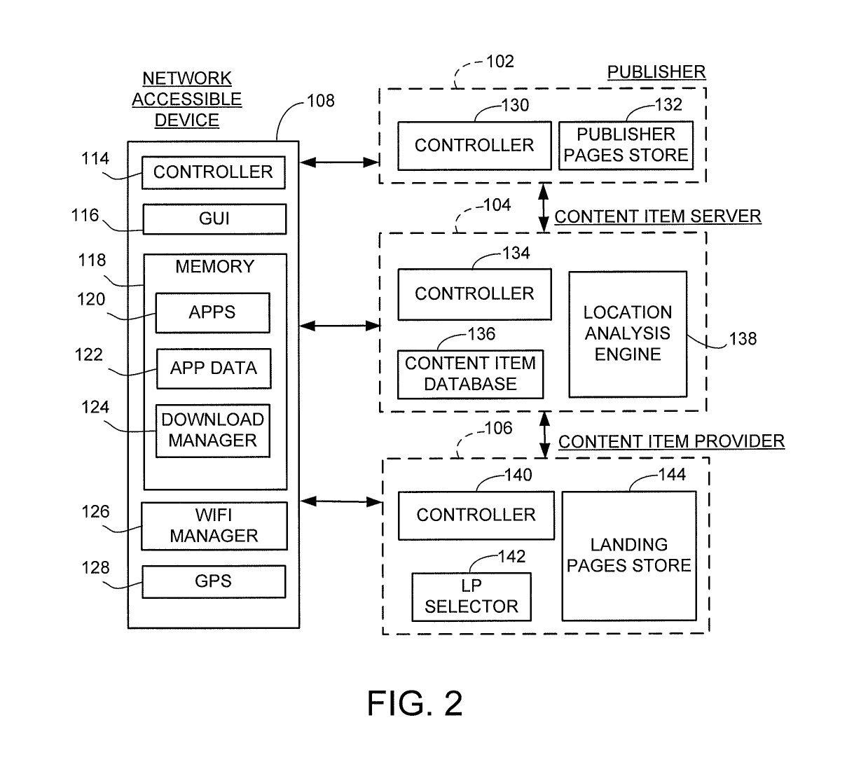

FIG. 2 shows aspects of the system 100 of FIG. 1 in accordance with some embodiments. An example of a network accessible (user) device 108 from FIG. 1 is contemplated as comprising a smart phone (mobile NAD) with a high speed Internet connection to communicate with the network 110. This device is merely for purposes of providing a concrete example and is not limiting.

The user device 108 includes a controller 114, a graphical user interface (GUI) 116 and memory 118. The controller 114 may be a programmable processor that uses associated operating system programming and application software (e.g., a web browser) in the memory to interact with the network 110. The GUI 116 may include a display monitor, keyboard, mouse, etc. The memory 118 may represent a hierarchical memory structure made up of various memory devices within the user device 108, including such elements as a non-volatile main memory (e.g., disc memory, solid-state drive, etc.), data transfer buffer, local processor (L1-L3) cache, etc. The memory 118 stores various operational modules including applications (apps) 120, application (app) data 122 and a download manager 124 for the device 108.

The device 108 can further include a WiFi manager 126 for recognizing WiFi signals associated with various WiFi zones and a global positioning system (GPS) 128 for use in determining the location of the NAD 108.

At this point, it will be understood that the user of the device 108 opens a web browser application or mobile application and requests a web page or application from the publisher 102. A controller 130 of the publisher 102 processes the request to deliver content for the selected web page from a publisher pages store 132.

The content item server 104 includes a controller 134, a content item database 136 (memory) for storing a population of available content items from content providers, and location analysis engine 138 to determine the location of the location associated with the content item provider NAD 108 at various times (i.e., when the content item is uploaded to the NAD 108).

The content item provider server 106 includes a controller 140, a landing page selector 142 to select which landing page from a landing page store 144 is displayed when a content item is “clicked.”

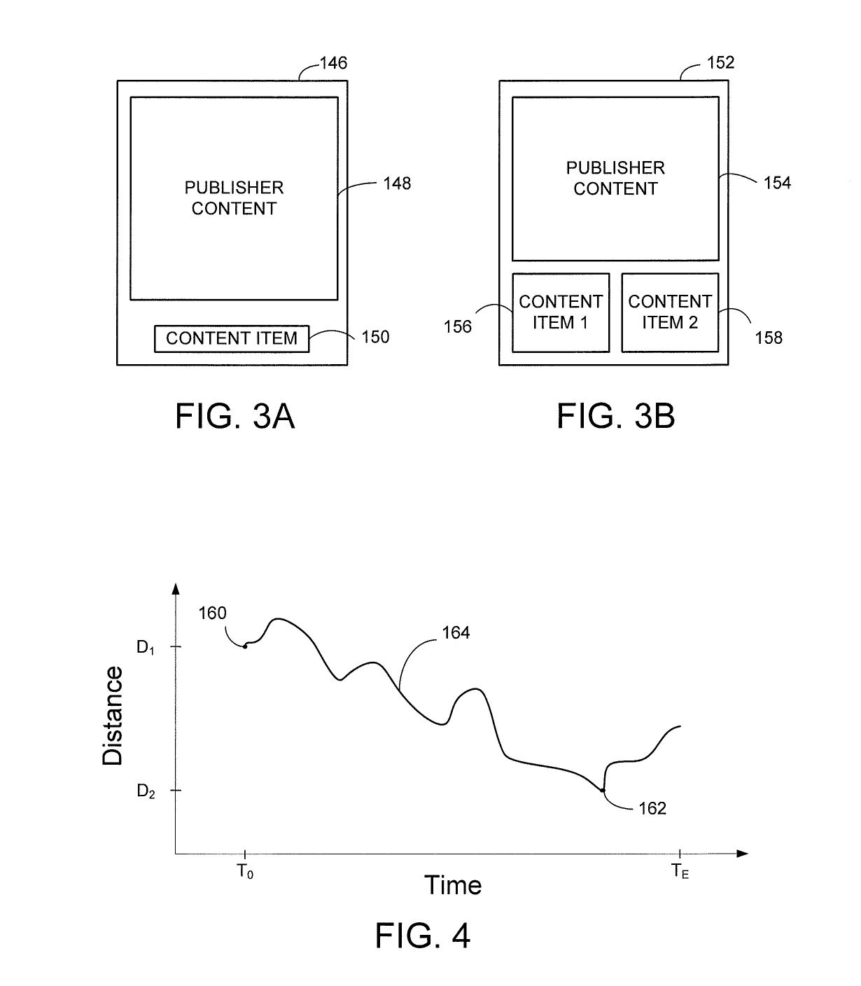

FIGS. 3A and 3B illustrate exemplary embodiments of publisher web pages 146 and 152 displaying publisher content 148 and 154, respectively. The web page 146, shown in FIG. 3A, includes a single content item 150 displayed thereon and the web page 152, shown in FIG. 3B, includes a plurality of content items 156, 158 displayed thereon. It should be understood and appreciated that a publisher web page and/or a mobile application can display the publisher's content and content items in any layout desired. There is no limit to how the web pages and/or mobile applications can be laid out, or the number of content items that can be displayed thereon.

FIG. 4 shows a graphical representation of an NAD's distance from the location associated with the content item provider over the predetermined amount of time. D₁ is the distance the user's NAD is from the location associated with the content item provider at the time (T₀) the content item is uploaded to the NAD. D₂ is the closest distance the user's NAD gets to the location associated with the content item provider during the predetermined amount of time after the content item is uploaded to the user's NAD. T_{E} is the end time of the predetermined amount of time that the distance of the user's NAD from the location associated with the content item provider is determined for the purposes of determining the amount of money to be transferred from the content item provider to the content item selector.

Reference numeral 160 represents the time (T₀) when the content item was first uploaded to the user's NAD 108 and the distance (D₁) the user's NAD was from the location associated with the content item provider. The change in distance of the user's NAD over the span of time from T₀ to T_{E} generates a path 164 of the user's NAD. Reference numeral 162 represents the time associated with the distance (D₂) wherein the user's NAD is closest to the location associated with the content item provider during the predetermined amount of time after the content item is uploaded to the user's NAD, or prior to T_{E}.

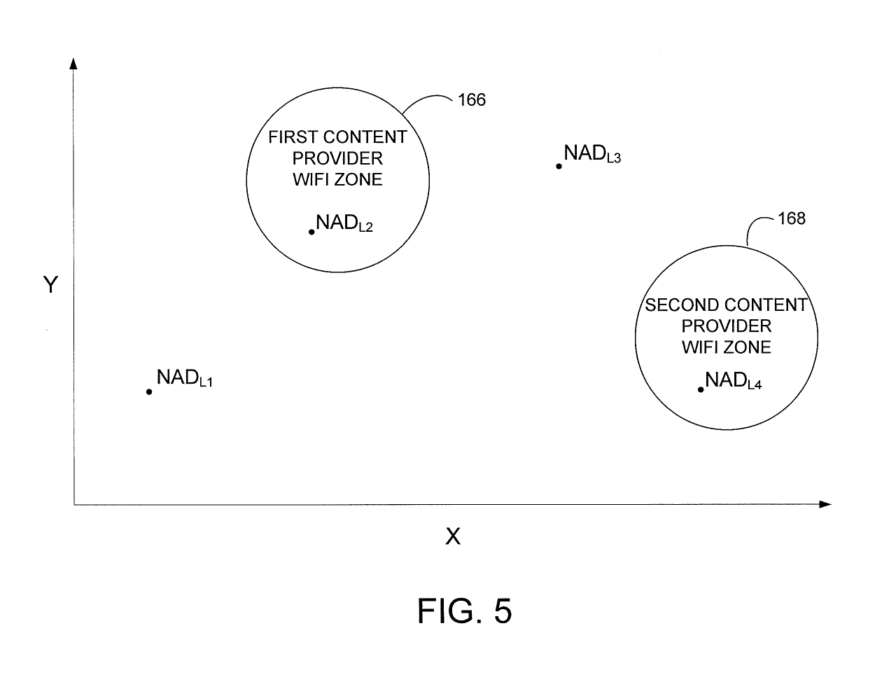

FIG. 5 shows a graphical representation of the present disclosure. The X axis and Y axis of FIG. 5 represent a spatial area. NAD_{L1} represents a first location of the user's NAD relative to various WiFi zones associated with various advertisers. NAD_{L2} represents a second location of the user's NAD within a first advertiser's WiFi zone 166. NAD_{L3} represents a third location of the user's NAD positioned outside of any WiFi zone. NAD_{L4} represents a fourth location of the user's NAD within a second advertiser's WiFi zone 168. It should be understood and appreciated that there could be numerous different WiFi zones that the user (and the user's NAD) travels through whereby and “handshake” occurs and the location of the user's NAD can be determined. These “handshake locations” can be used to determine how close the user's NAD is from the location associated with the content item provider.

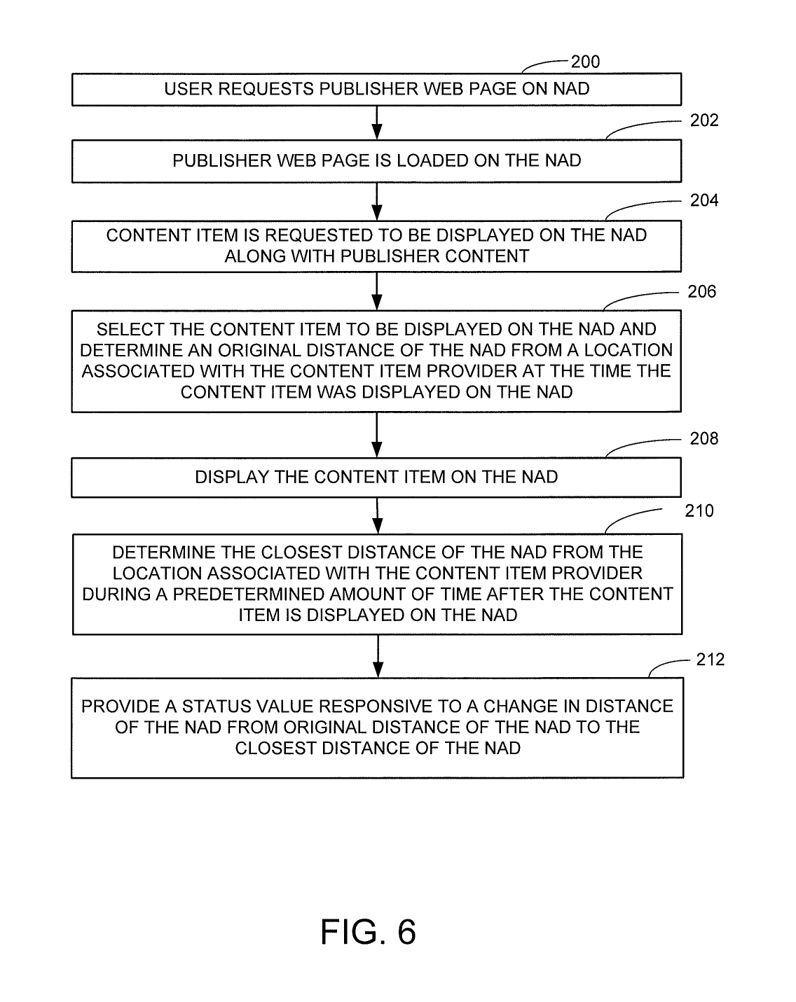

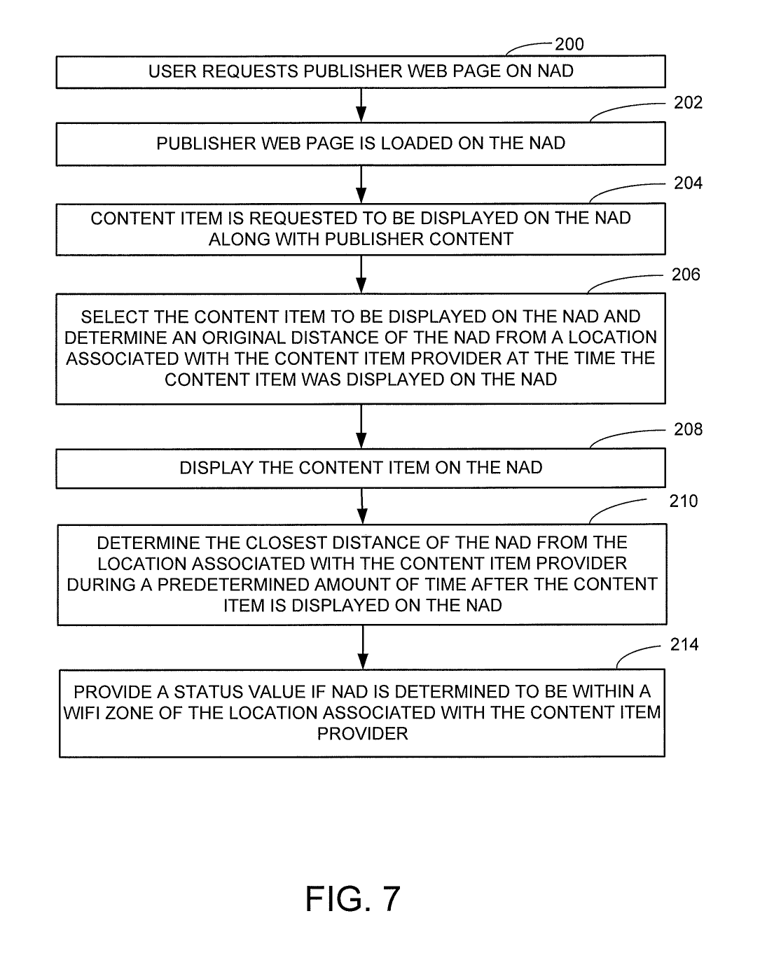

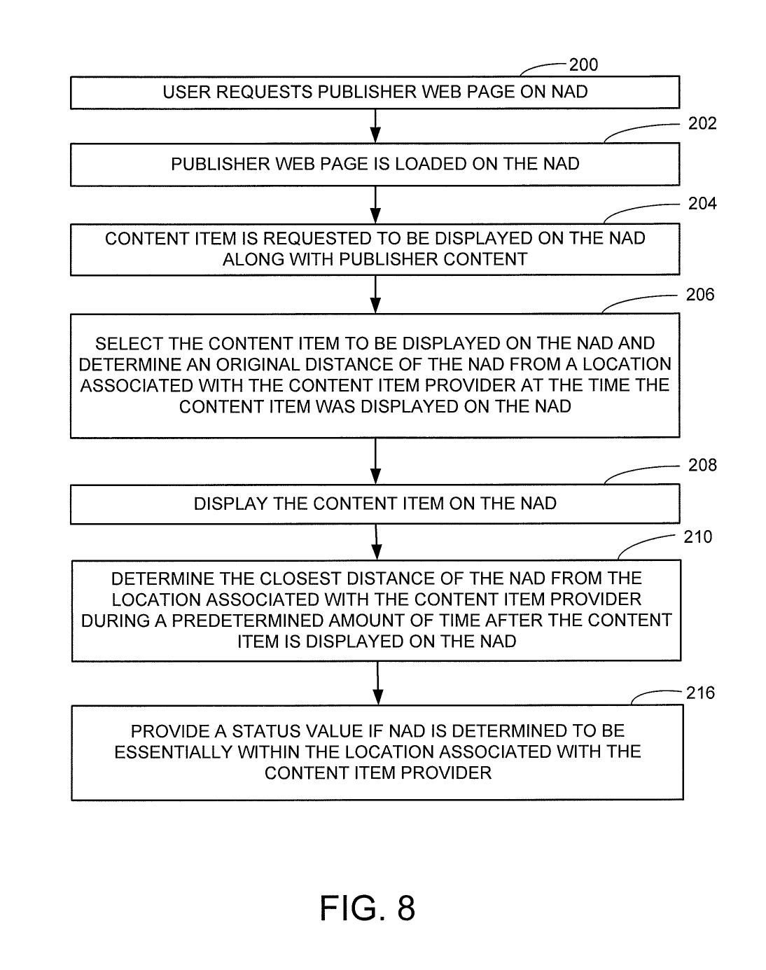

FIG. 6 depicts a general flow chart of steps that may be carried out to determine the status value for the selection of the content item provider's content item to be displayed on the NAD. The status value is determined from the change in distance of an NAD from the original location of the NAD when the content item is displayed thereon and the location of the NAD when the NAD is closest to the location associated with the content item provider during the predetermined amount of time after the content item is uploaded to the user's NAD. First, a user requests a publisher web page (step 200) on the user's NAD 108. The NAD 108 loads the publisher's web page (step 202) on the NAD 108 and a content item is requested (step 204) to be displayed on the publisher's web page, such as by a script that is activated during step 200. A content item selection process (block 206) is undertaken to select a content item to be displayed on the publisher's web page and the distance the NAD 108 is from a location associated with the content item provider is determined. Typically, it is in this step where a first status value is determined. The content item is returned for display at step 208 on the publisher's web page. The user can now view the web page, complete with publisher's content and at least one content item.

Once the content item is returned for display, the closest distance the NAD 108 is from the location associated with the content item provider (step 210) is determined during a predetermined amount of time after the content item is displayed on the NAD 108. It should be understood and appreciated that the closest distance is a distance that is less than the original distance. At this point, a number of steps could occur. In one embodiment, a second status value is determined (step 212) in lieu of the first status value and responsive to the change in distance from where the NAD 108 was when the content item was displayed thereon, and the location associated with the closest distance the NAD 108 was to the location associated with the content item provider. In a further embodiment, the second status value is only provided in lieu of the first status value if the change in distance from where the NAD 108 was when the content item was displayed thereon and the location associated with the closest distance the NAD 108 was to the location associated with the content item provider changes a predetermined amount.

In yet another embodiment, a status value is only provided if the distance between the user's NAD 108 and the location associated with the content item provider decreases during the predetermined amount of time after the content item is displayed on the NAD 108. In a further embodiment, a third status value is provided (step 214) in lieu of the first status value, if the user's NAD 108 is determined to be within a WiFi zone associated with the location associated with the content item provider within the predetermined amount of time from when the content item was displayed on the user's NAD 108. In another embodiment, a fourth status value is provided (step 216) in lieu of the first status value, if the user's NAD 108 is determined to be essentially located at the location associated with the content item provider within the predetermined amount of time from when the content item was displayed on the user's NAD 108.

It should be understood and appreciated that any variation and/or combination of steps 212, 214, and 216 can be implemented. For example, the system 100 can implement all three steps. In this exemplary embodiment, the second status value would replace the first status value. The third status value would replace the second status value. And, the fourth status value would replace the third status value. In another exemplary embodiment, the system 100 can incorporate steps 212 and 216. In this example, the second status value would replace the first status value. And, the fourth status value would replace the second status value.

In situations in which systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or user's geographic location may be generalized where location information is obtained (such as city, ZIP code, or state level), so that a particular location of a user cannot be determined. Thus, the user my have control over how information is collected about the user and used by a content server.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A computer implemented method comprising:
displaying a content item associated with a content provider on a network accessible device, the content item provided to the network accessible device by a content item selector;
detecting a first distance between the network accessible device and a location associated with the content provider;
subsequently detecting a different, second distance between the network accessible device and the location associated with the content provider;
determining a change in distance between the first and second distances; and
storing data in a memory of the content item selector that associates the change in distance with the displayed content item.

2. The method of claim 1 wherein the second distance is a minimum distance between the network accessible device and the location associated with the content provider during the predetermined amount of time after the content item is displayed on the network accessible device.

3. The method of claim 1 wherein the stored data associated with the change in distance is provided with a status value.

4. The method of claim 3 wherein the status value is provided only if the second distance is less than the first distance during the predetermined amount of time.

5. The method of claim 3 wherein the status value is provided only if the network accessible device is located at the location associated with the content provider during the predetermined amount of time.

6. The method of claim 3 wherein the status value is provided only if the network accessible device is located within a WiFi zone of the location associated with the content provider during the predetermined amount of time.

7. The method of claim 3 wherein the status value is provided only if the change in distance is a predetermined change in distance.

8. The method of claim 6 further including determining a unique identifier of the network accessible device when the content item is displayed thereon, determining the unique identifier of the network accessible device when the device is within the WiFi zone of the location associated with the content provider, and verifying the unique identifier of the device is the same.

9. An apparatus comprising:
a memory which stores a population of content items from content providers available to be provided to a network accessible device, the content item provided to the network accessible device by a content item selector;
a location analysis engine adapted to determine a first distance of the network accessible device from a location associated with the content provider, determine a second distance of the network accessible device from the location associated with the content provider, determine a change in distance between the first distance and the second distance, and store data in a memory of the content item selector that associates the change in distance with the displayed content item, the second distance being the closest distance the network accessible device is to the location associated with the content provider during a predetermined amount of time after the content item is displayed on the network accessible device; and
a second memory for storing the first distance, the second distance, the change in distance and the stored data associated with the change in distance with the displayed content item.

10. The apparatus of claim 9 wherein the second distance is a minimum distance between the network accessible device and the location associated with the content provider during the predetermined amount of time after the content item is displayed on the network accessible device.

11. The apparatus of claim 9 wherein the stored data associated with the change in distance is provided with a status value.

12. The apparatus of claim 11 wherein the status value is provided only if the second distance is less than the first distance during the predetermined amount of time.

13. The apparatus of claim 11 wherein the status value is transferred only if the network accessible device is located at the location associated with the content provider during the predetermined amount of time.

14. The apparatus of claim 11 wherein the status value is provided only if the network accessible device is located within a WiFi zone of the location associated with the content provider during the predetermined amount of time.

15. The apparatus of claim 14 wherein a unique identifier of the network accessible device is determined when the content item is displayed thereon, the unique identifier of the network accessible device is determined when the device is within the WiFi zone of the location associated with the content provider, and the unique identifier of the device is verified to be the same.

16. A computer-readable data storage medium on which is stored programming instructions adapted for execution by one or more processors to:
display a content item associated with a content provider on a network accessible device, the content item provided to the network accessible device by a content item selector;
detect a first distance between the network accessible device and a location associated with the content provider;
subsequently detect a different, second distance between the network accessible device and the location associated with the content provider;
determine a change in distance between the first distance and the second distance; and
store data in a memory of the content item selector that associates the change in distance with the displayed content item.

17. The medium of claim 16 wherein the second distance is a minimum distance between the network accessible device and the location associated with the content provider during the predetermined amount of time after the content item is displayed on the network accessible device.

18. The medium of claim 16 wherein the stored data associated with the change in distance is provided with a status value.

19. The medium of claim 18 wherein the status value is provided only if the second distance is less than the first distance during the predetermined amount of time.

20. The medium of claim 18 wherein the status value is provided only if the network accessible device is located at the location associated with the content provider during the predetermined amount of time.

21. The medium of claim 18 wherein the status value is provided only if the network accessible device is located within a WiFi zone of the location associated with the content provider during the predetermined amount of time.

22. The medium of claim 21 wherein a unique identifier of the network accessible device is determined when the content item is displayed thereon, the unique identifier of the network accessible device is determined when the device is within the WiFi zone of the location associated with the content provider, and the unique identifier of the device is verified to be the same.
